(19) United States
(12) Patent Application Publication
(10) Pub. No.: US 2021/0192679 A1
(43) Pub. Date: Jun. 24, 2021

(54) ELECTRONIC DEVICE AND OMNI-DIRECTIONAL IMAGE DISPLAY METHOD OF ELECTRONIC DEVICE

(71) Applicant: Samsung Electronics Co., Ltd., Gyeonggi-do (KR)

(72) Inventors: Jeongsup JEONG, Gyeonggi-do (KR); Myungkyu CHOI, Gyeonggi-do (KR)

(21) Appl. No.: 16/962,950

(22) PCT Filed: Feb. 7, 2019
(86) PCT No.: PCT/KR2019/001506

§ 371 Date: Jul. 17, 2020

(30) Foreign Application Priority Data
Feb. 9, 2018 (KR) 10-2018-0016438

(51) Int. Cl. G06T 3/00; G06T 3/20

(52) U.S. Cl. CPC G06T 3/0043; G06T 3/20; G06T 3/0087

(57) ABSTRACT

An electronic device according to various embodiments of the present invention may comprise: at least one wireless and/or wired communication circuit; a display; a processor operatively connected to the communication circuit and the display; and a memory operatively connected to the processor and storing an application including a user interface configured to display an omni-directional mage on the display, wherein the memory stores instructions that, when executed, cause the processor to: receive an omni-directional image through the communication circuit; store the omni-directional image in the memory; analyze the received omni-directional image; select one of multiple display configurations of the omni-directional image at least on the basis of the analysis; and display the omni-directional image on the display according to the selected display configuration. Various other embodiments are possible.

### TECHNICAL FIELD

Various embodiments of the present invention relate to an electronic device and method for displaying images captured in all directions by the electronic device.

### BACKGROUND ART

An omni-directional or multi-directional imaging camera system refers to a camera system that may capture images in all or some directions with respect to a fixed gaze point. For example, an omni-directional or multi-directional image may be an image that includes all the views that an observer can see when he or she spins in place and looks up or down. An omni-directional imaging camera system may capture images in all directions using a camera equipped with a specific type of mirror, e.g., a hyperboloid mirror, or multiple cameras. The camera may provide captured omni-directional images to an electronic device.

### DETAILED DESCRIPTION OF THE INVENTION

### Technical Problem

A camera may provide an omni-directional image to an electronic device, and the electronic device may display the omni-directional image. The electronic device may convert the omni-directional image into two-dimension (2D) image data and display an image in the direction corresponding to the user's input, via the image data.

The omni-directional image includes all of the images corresponding to all the view directions. Thus, the user may have difficulty in distinguishing the plurality of omni-directional images by identifying the converted two-dimension image.

According to various embodiments of the present invention, an electronic device and method for displaying omni-directional image data by the electronic device may capture a captured image in an omni-directional image and configure the omni-directional image so that the object is placed in a specific position of a two-dimension image.

### Technical Solution

According to various embodiments of the present invention, an electronic device comprises at least one wireless and/or wired communication circuit, a display, a processor operatively connected with the communication circuit and the display, and a memory operatively connected with the processor and storing an application including a user interface configured to display an omni-directional image on the display. The memory may store instructions executed to enable the processor to receive the omni-directional image via the communication circuit, store the omni-directional image in the memory, perform analysis on the received omni-directional image, select one of a plurality of display settings for the omni-directional image based on, at least, the analysis, and display the omni-directional image on the display according to the selected display setting.

According to various embodiments of the present invention, a method of displaying an omni-directional image by an electronic device comprises receiving the omni-directional image from an external electronic device, storing the omni-directional image in a memory of the electronic device, performing analysis on the received omni-directional image, selecting one of a plurality of display settings for the omni-directional image based on, at least, the analysis, and displaying the omni-directional image on a display according to the selected display setting.

According to various embodiments of the present invention, there is provided a storage medium storing instructions configured to be executed by at least one circuit to enable the at least one circuit to perform at least one operation that may include receiving the omni-directional image from an external electronic device, storing the omni-directional image in a memory of the electronic device, performing analysis on the received omni-directional image, selecting one of a plurality of display settings for the omni-directional image based on, at least, the analysis, and displaying the omni-directional image on a display according to the selected display setting.

### Advantageous Effects

According to various embodiments of the present invention, an electronic device and method for displaying an omni-directional image by the electronic device may capture a captured image in an omni-directional image and configure the omni-directional image so that the object is placed in a specific position of a two-dimension image, allowing the user to easily identify the captured object.

According to various embodiments of the present invention, an electronic device and method for displaying an omni-directional image by the electronic device may identify at least one of various display settings according to the position of the user or an object captured in the omni-directional image, enabling display of the omni-directional image according to a specific display setting.

### BRIEF DESCRIPTION OF DRAWINGS

FIG. 1 is a view illustrating an electronic device in a network environment according to various embodiments;

FIG. 2 is a block diagram illustrating an example configuration of a camera module according to various embodiments of the present invention;

FIG. 3 is a view illustrating example electronic devices configuring an image processing system according to various embodiments of the present invention;

FIG. 4 is a block diagram illustrating an example configuration of an electronic device according to various embodiments of the present invention;

FIG. 5 is a flowchart illustrating an example operation of displaying an omni-directional image by an electronic device according to various embodiments of the present invention;

FIG. 6 is a view illustrating a 3D space according to various embodiments of the present invention;

FIG. 7 is a view illustrating an example omni-directional image converted into a two-dimension image according to various embodiments of the present invention;

FIG. 8 is a view illustrating an example omni-directional image before circle center candidate value transform is performed according to various embodiments of the present invention;

FIG. 9 is a view illustrating an example of an omni-directional image displayed on an electronic device according to various embodiments of the present invention;

FIG. 10 is a view illustrating an example of an omni-directional image displayed on an electronic device according to various embodiments of the present invention;

FIGS. 11A and 11B are views illustrating various example omni-directional images to which various transform schemes are applied to identify display settings according to various embodiments of the present invention;

FIGS. 12A and 12B are views illustrating various example omni-directional images to which various transform schemes are applied to identify display settings according to various embodiments of the present invention;

FIGS. 13, 14, and 15 are views illustrating various operations for detecting a line from an omni-directional image to identify display settings according to various embodiments of the present invention; and

FIG. 16 is a view illustrating an example screen layout displaying a list of omni-directional images stored in an electronic device according to various embodiments of the present invention.

### MODE FOR CARRYING OUT THE INVENTION

Hereinafter, embodiments of the present disclosure are described with reference to the accompanying drawings. However, it should be appreciated that the present disclosure is not limited to the embodiments and the terminology used herein, and all changes and/or equivalents or replacements thereto also belong to the scope of the present disclosure. The same or similar reference denotations may be used to refer to the same or similar elements throughout the specification and the drawings. It is to be understood that the singular forms “a,” “an,” and “the” include plural references unless the context clearly dictates otherwise. As used herein, the terms “A or B” or “at least one of A and/or B” may include all possible combinations of A and B. As used herein, the terms “first” and “second” may modify various components regardless of importance and/or order and are used to distinguish a component from another without limiting the components. It will be understood that when an element (e.g., a first element) is referred to as being (operatively or communicatively) “coupled with/to,” or “connected with/to” another element (e.g., a second element), it can be coupled or connected with/to the other element directly or via a third element.

As used herein, the terms “configured to” may be interchangeably used with other terms, such as “suitable for,” “capable of,” “modified to,” “made to,” “adapted to,” “able to,” or “designed to” in hardware or software in the context. Rather, the term “configured to” may mean that a device can perform an operation together with another device or parts. For example, the term “processor configured (or set) to perform A, B, and C” may mean a generic-purpose processor (e.g., a CPU or application processor) that may perform the operations by executing one or more software programs stored in a memory device or a dedicated processor (e.g., an embedded processor) for performing the operations.

For example, examples of the electronic device according to embodiments of the present disclosure may include at least one of a smartphone, a tablet personal computer (PC), a mobile phone, a video phone, an e-book reader, a desktop PC, a laptop computer, a netbook computer, a workstation, a server, a personal digital assistant (PDA), a portable multimedia player (PMP), a MP3 player, a medical device, a camera, or a wearable device. The wearable device may include at least one of an accessory-type device (e.g., a watch, a ring, a bracelet, an anklet, a necklace, glasses, contact lenses, or a head-mounted device (HMD)), a fabric- or clothes-integrated device (e.g., electronic clothes), a body attaching-type device (e.g., a skin pad or tattoo), or a body implantable device. In some embodiments, examples of the smart home appliance may include at least one of a television, a digital video disk (DVD) player, an audio player, a refrigerator, an air conditioner, a cleaner, an oven, a microwave oven, a washer, a drier, an air cleaner, a set-top box, a home automation control panel, a security control panel, a TV box (e.g., Samsung HomeSync™ Apple TV™, or Google TV™), a gaming console (Xbox™, PlayStation™), an electronic dictionary, an electronic key, a camcorder, or an electronic picture frame.

According to an embodiment of the present disclosure, the electronic device may include at least one of various medical devices (e.g., diverse portable medical measuring devices (a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global navigation satellite system (GNSS) receiver, an event data recorder (EDR), a flight data recorder (FDR), an automotive infotainment device, an sailing electronic device (e.g., a sailing navigation device or a gyro compass), avionics, security devices, vehicular head units, industrial or home robots, drones, automatic teller's machines (ATMs), point of sales (POS) devices, or internet of things (IoT) devices (e.g., a bulb, various sensors, a sprinkler, a fire alarm, a thermostat, a street light, a toaster, fitness equipment, a hot water tank, a heater, or a boiler). According to various embodiments of the disclosure, examples of the electronic device may at least one of part of a piece of furniture, building/structure or vehicle, an electronic board, an electronic signature receiving device, a projector, or various measurement devices (e.g., devices for measuring water, electricity, gas, or electromagnetic waves). According to embodiments of the present invention, the electronic device may be flexible or may be a combination of the above-enumerated electronic devices.

According to an embodiment of the disclosure, the electronic devices are not limited to those described above. As used herein, the term “user” may denote a human or another device (e.g., an artificial intelligent electronic device) using the electronic device.

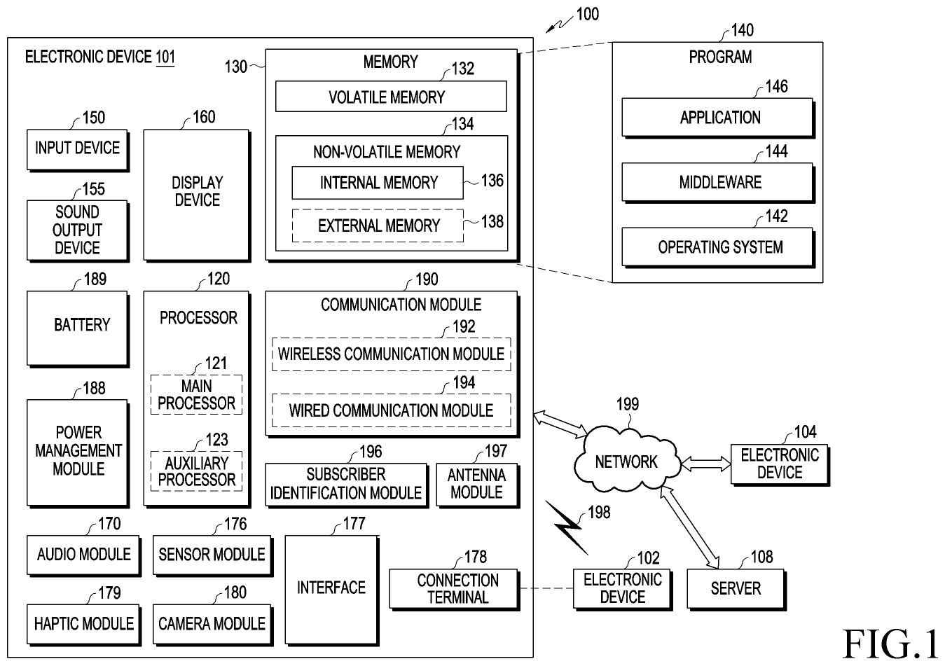

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, or a keyboard.

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 388 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device). According to an embodiment, the antenna module 197 may include one or more antennas, and, therefrom, at least one antenna appropriate for a communication scheme used in the communication network, such as the first network 198 or the second network 199, may be selected, for example, by the communication module 190 (e.g., the wireless communication module 192). The signal or the power may then be transmitted or received between the communication module 190 and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

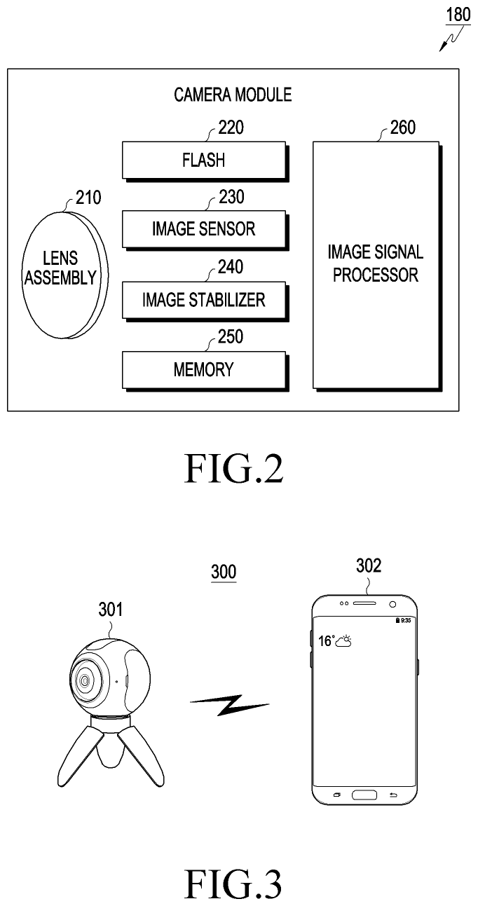

FIG. 2 is a block diagram illustrating an example configuration of a camera module according to various embodiments of the present invention.

Referring to FIG. 2, the camera module 180 may include a lens assembly 210, a flash 220, an image sensor 230, an image stabilizer 240, memory 250 (e.g., buffer memory), or an image signal processor 260. The lens assembly 210 may collect light emitted or reflected from an object whose image is to be taken. The lens assembly 210 may include one or more lenses. According to an embodiment, the camera module 180 may include a plurality of lens assemblies 210. In this case, the camera module 180 may be, e.g., a dual camera, a 360-degree camera, or a spherical camera. The plurality of lens assemblies 210 may have the same lens attribute (e.g., view angle, focal length, auto-focusing, f number, or optical zoom), or at least one lens assembly may have at least one different lens attribute from another lens assembly. The lens assembly 210 may include, for example, a wide-angle lens or a telephoto lens. The flash 220 may emit light that is used to reinforce light from an object. The flash 220 may include one or more light emitting diodes (LEDs) (e.g., a red-green-blue (RGB) LED, a white LED, an infrared (IR) LED, or an ultraviolet (UV) LED) or a xenon lamp.

The image sensor 230 may obtain an image corresponding to an object by converting light transmitted from the object via the lens assembly 210 into an electrical signal. According to an embodiment, the image sensor 230 may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor 230 may be implemented as, e.g., a charged coupled device (CCD) sensor or a complementary metal oxide semiconductor (CMOS) sensor.

The image stabilizer 240 may move in a particular direction, or control (e.g., adjust the read-out timing of), the image sensor 230 or at least one lens included in the lens assembly 210 to at least partially compensate for a negative effect (e.g., image blurring) on a captured image, which is caused by the motion of the camera module 180 or the electronic device 101 including the camera module 2680, in response to the motion. According to an embodiment, the image stabilizer 240 may be implemented as, e.g., an optical image stabilizer. The image stabilizer 240 may sense such movement using a sensor module 176 (e.g., a gyro sensor or an acceleration sensor) disposed inside or outside the camera module 180.

The memory 250 may store, at least temporarily, at least part of an image obtained via the image sensor 230 for a subsequent image processing task. For example, when image capturing is delayed due to shutter lag or multiple images are quickly captured, a raw image obtained (e.g., a high-resolution image) may be stored in the memory 250, and its corresponding copy (e.g., a low-resolution image) may be previewed through the display device 160. Thereafter, if a specified condition is met (e.g., by a user's input or system command), at least part of the raw image stored in the memory 250 may be obtained and processed, for example, by the image signal processor 260. According to an embodiment, the memory 250 may be configured as at least part of the memory 130 or as a separate memory that is operated independently from the memory 130.

The image signal processor 260 may perform image processing (e.g., depth map generation, three-dimensional (3D) modeling, panorama generation, feature point extraction, image mixing, or image compensation (e.g., noise canceling, resolution adjustment, brightness adjustment, blurring, sharpening, or softening)) on an image obtained through the image sensor 230 or an image stored in the memory 250. Additionally or alternatively, the image signal processor 260 may perform control (e.g., exposure time control or read-out timing control) with respect to at least one (e.g., the image sensor 230) of the components included in the camera module 180. An image processed by the image signal processor 260 may be stored back in the memory 250 for further processing, or may be provided to an external component (e.g., the memory 130, the display device 160, the electronic device 102, the electronic device 104, or the server 108) outside the camera module 180. According to an embodiment, the image signal processor 260 may be included as at least a component of the processor 120, or as a separate processor that is operated independently from the processor 120. When the image signal processor 260 is configured as a separate processor, images processed by the image signal processor 260 may be displayed through the display device 160 as they are or after further processed by the processor 120.

According to an embodiment, the electronic device 101 may include two or more camera modules 180 with different attributes or functions. In this case, at least one of the camera modules 180 may be, e.g., a wide-angle camera or a front camera while at least one other camera module may be a telephoto camera or a rear camera.

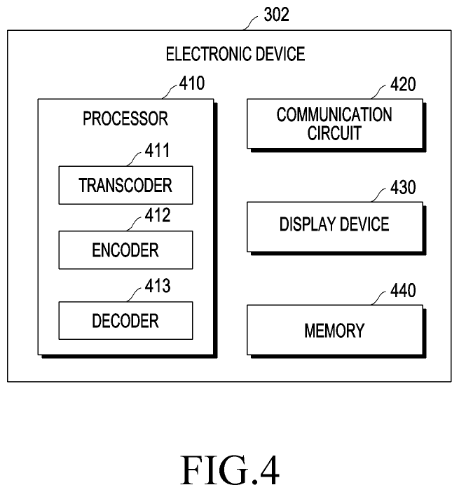

FIG. 3 is a view illustrating example electronic devices configuring an image processing system according to various embodiments of the present invention.

Referring to FIG. 3, the image processing system 300 may include an image capturing device 301 and an electronic device 302.

The image capturing device 301 may include at least one lens or camera (e.g., the camera module 180) for capturing omni-directional images. In the following description, the term “omni-directional” may encompass the term “multi-directional.” For example, the image capturing device 301 may capture a 360-degree omni-directional image with respect to a fixed position (e.g., the position of the image capturing device 301). The omni-directional image may be image data (e.g., 360-degree raw data) including all the views that the user sees when he or she spins in place and looks up or down.

According to an embodiment, the lens of the image capturing device 301 may be a fisheye lens that may have a view angle of 180 degrees or more. For example, when the fisheye lens is positioned towards the sky, the image capturing device 301 may capture a single piece of image of an area from a constellation to the horizon. The image capturing device 301 may include a plurality of fisheye lenses to capture images in all directions.

According to an embodiment of the present invention, the image capturing device 301 may include a plurality of cameras with a predetermined view angle to capture images in all directions. In this case, the plurality of cameras may be provided in the image capturing device 301 to cover all directions with respect to one point. As another example, the image capturing device 301 having one or more cameras may automatically or manually be moved (e.g., moving in the direction of pitch, yaw, or roll) to capture images in all directions.

According to an embodiment of the present invention, the image capturing device 301 may include a plurality of cameras with a predetermined angle corresponding to the user's left and right eyes. For example, the image capturing device 301 may capture a stereoscopic image including multiple omni-directional images by capturing images in all directions corresponding to the user's left and right eyes.

According to various embodiments of the present invention, the electronic device 302 may identify the omni-directional image received from the image capturing device 301 and identify display settings designated for each object captured in the omni-directional image. For example, the electronic device 302 may convert the omni-directional image into a two-dimension image according to the identified display settings and display the two-dimension image.

According to various embodiments of the present invention, the image capturing device 301 or the electronic device 302 may be configured as the electronic device 101 of FIG. 1 or may be configured to include at least some of the components of the electronic device 101. For example, the image capturing device 301 may be configured to include the camera module 180 of the electronic device 101 of FIG. 1.

According to an embodiment of the present invention, the image capturing device 301 may store the captured image and relevant metadata (e.g., direction, range, area, or position of image capturing). The metadata may include information about the position, motion, direction, and properties (e.g., camera calibration parameters or image capturing state information) of the image capturing device 301 which is detected through a sensor (e.g., a global positioning system (GPS), wireless-fidelity (Wi-Fi) module, fingerprint sensor, gyroscope sensor, acceleration sensor, geo-magnetic sensor, or altitude sensor) included in the image capturing device 301, and the image capturing device 301 may store the metadata in association with at least one of captured images.

According to an embodiment of the present invention, the image capturing device 301 may store the metadata with the metadata mapped (or associated) with identification information for each frame. For example, the image capturing device 101 may store sensing information about the time of capturing each frame along with the identification information about the frame.

According to an embodiment of the present invention, the image capturing device 301 may map the captured omni-directional image to a two-dimensional (2D) plane image, encode the mapped 2D plane image, and store the encoded image in the memory or transmit the encoded image to the electronic device 302.

According to various embodiments of the present invention, the control device 302 may identify the image received from the image capturing device 301 with an image reproduction and processing device. For example, the received image may include the raw data (360-degree raw data) of the omni-directional image or the omni-directional image data stitched and transmitted by the image capturing device 301.

According to various embodiments of the present invention, the electronic device 302 may decode the data of the two-dimension image received from the image capturing device 301. The electronic device 302 may perform rendering using the decoded two-dimension image and display the rendered frames.

According to various embodiments of the present invention, the electronic device 302 may include various electronic devices, such as a virtual reality (VR) device, such as an HMD, a smartphone, a personal computer (PC), a television (TV), a tablet PC, or other various image processing electronic devices, and the electronic device 103 may be coupled to a housing prepared to be put on the user's head. The electronic device 302 coupled with the housing may be worn on the user's head firmly regardless of the user's motion, so that the user may observe images displayed on the display of the electronic device 302 or view images received from the image capturing device 301.

According to various embodiments of the present invention, the image capturing device 301 and the electronic device 302 may include cellular modules, Wi-Fi modules, Bluetooth modules, ZigBee modules, or other communication modules to communicate with each other.

According to an embodiment of the present invention, the electronic device 302 may store a 3D application (or a VR application) and a 3D graphic library. The 3D application may be an application capable of providing a user with a screen that looks real. The VR means a virtual space that may be viewed around the user (or a reference point or camera), and the VR may be one obtained by rendering, on the screen, a virtual space able to represent 360 degrees, e.g., a 360-degree omni-directional image or image content, or a 3D graphic modeling space.

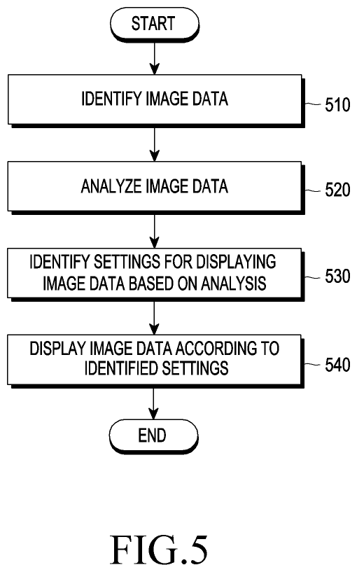

FIG. 4 is a block diagram illustrating an example configuration of an electronic device according to various embodiments of the present invention.

Referring to FIG. 4, an electronic device 302 (e.g., the electronic device 101) may include a processor 410 (e.g., the processor 120), a communication circuit 420 (e.g., the communication module 190), a display device 430 (e.g., the display device 160), and a memory 440 (e.g., the memory 130).

The processor 410 may perform the overall operation of the electronic device 302. The processor 410 may perform control to receive omni-directionally captured image data from an external electronic device (e.g., the camera module 180), store the data in the memory 440, and display the received data through the display device 430.

According to various embodiments of the present invention, the processor 410 may include a transcoder 411, an encoder 412, and a decoder 413.

The transcoder 411 may map the omni-directional image to a 2D image. For example, the transcoder 411 may map two images which have been captured by a fisheye lens and received from the image capturing device to a 3D image and map the same to a 2D image. In this case, to map the omni-directional image to the 3D image, the transcoder 411 may map the omni-directional image to an outer or inner surface of a virtual 3D model.

According to an embodiment of the present invention, the transcoder 411 may generate metadata for the relationship in coordinates between the mapped 3D image and the mapped 2D image while simultaneously mapping the 3D image to the 2D image.

The encoder 412 may encode the 2D image received from the transcoder 411 and store the encoded image in the form of streaming or a file. For example, the encoder 412 may perform encoding based on a codec standard, e.g., H.264, MPEG-4, or HEVC, and store the encoded image data in the memory 440 in the form of a video or still image.

The decoder 413 may decode the data delivered from the memory 440. The decoder 413 may perform decoding using the same codec standard (e.g., H.264, MPEG-4, or HEVC) as the codec standard that was used upon encoding the two-dimension image in the device that has transmitted the omni-directional image.

According to various embodiments of the present invention, the processor 410 may perform rendering based on the decoded two-dimension image (hereinafter, “input frame”). For example, the processor 410 may further use metadata for rendering. The metadata may be generated on the transmit part and delivered to the receive part or may previously be stored in a storage unit (not shown) of the receive part. For example, where JPEG encoding has been performed on the transmit part, the metadata may be contained in the exif field of the JPEG, and where MPEG-4 compression has been performed on the transmit part, the metadata may be contained in the moov field of the MPEG-4. The metadata may be included in an end of the image frame.

The communication circuit 420 may receive omni-directional image data from an external electronic device (e.g., the image capturing device 301). The omni-directional image data may include omni-directional images and meta data for a specific omni-directional image. The metadata may include sensing information (e.g., the position or direction of the image capturing device, or motion information or image capturing range information about the image capturing device) sensed by the external electronic device upon capturing the omni-directional image or image identification information.

The display device 430 may be communicably connected with the electronic device 302 and be positioned inside or outside the electronic device 302. The display device 430 may display the omni-directional image converted into a two-dimension image via the processor 410 (or rendering unit (not shown)).

The memory 440 may store the omni-directional image received from the external electronic device and meta data for the object captured in the omni-directional image. For example, the meta data for the object may include information indicating whether a designated object has been captured, the kind of object (e.g., a thing, figure, or scene), object identification information (e.g., user ‘A’ of a specific electronic device), or coordinates at which the object is displayed in the image.

According to various embodiments of the present invention, an electronic device 302 comprises at least one wireless and/or wired communication circuit 420, a display 430, a processor 410 operatively connected with the communication circuit 420 and the display 410, and a memory 440 operatively connected with the processor and storing an application including a user interface configured to display an omni-directional image on the display 440. The memory 440 may store instructions executed to enable the processor 410 to receive the omni-directional image via the communication circuit 420, store the omni-directional image in the memory 440, perform analysis on the received omni-directional image, select one of a plurality of display settings for the omni-directional image based on, at least, the analysis, and display the omni-directional image on the display 430 according to the selected display setting.

According to various embodiments of the present invention, the instructions may be part of the application program.

According to various embodiments, the plurality of display settings may include at least two of an equirectangular format, a cubic format, a little planet cylindrical panorama format, an arc format, a rectilinear format, or a partial spherical format.

According to various embodiments of the present invention, the instructions may be configured to enable the processor 410 to perform analysis on raw data of the omni-directional image to analyze an object or pattern.

According to various embodiments of the present invention, the instructions may be configured to enable the processor 410 to determine whether a user of the electronic device has been captured in the omni-directional image by analyzing a form of an object captured in the omni-directional image and as the user of the electronic device is captured in the omni-directional image, process the omni-directional image to allow an object corresponding to the user to be positioned in a center of a two-dimension image.

According to various embodiments of the present invention, the instructions may be configured to enable the processor 410 to identify a display setting which has been selected by the user a designated number of times or more among the plurality of display settings and convert the omni-directional image into a two-dimension image according to the identified display setting.

According to various embodiments of the present invention, the instructions may be configured to enable the processor 410 to, when an object corresponding to a figure cannot be identified or a background corresponding to a predesignated position is captured in the omni-directional image, convert the omni-directional image into a two-dimension image to allow an image area in a designated view direction of the omni-directional image in a panoramic form to be positioned in a center.

According to various embodiments of the present invention, the instructions may be configured to enable the processor 410 to, as a designated application or menu is selected, display a list of a plurality of omni-directional images stored in the electronic device, when a first omni-directional image in the list is selected, process the first omni-directional image according to at least one display setting to thereby generate at least one two-dimension image, and display the at least one generated two-dimension image.

According to various embodiments of the present invention, the instructions may be configured to enable the processor 410 to allow different users to receive information about the number of times in which the at least one display setting has been selected from a server (e.g., the server 108) through the communication circuit 420, and display the at least one two-dimension image in an order corresponding to the received information.

According to various embodiments of the present invention, the instructions may be configured to enable the processor 410 to identify a predesignated display order depending on a kind of object captured in the omni-directional image and display the at least one two-dimension image in the identified display order.

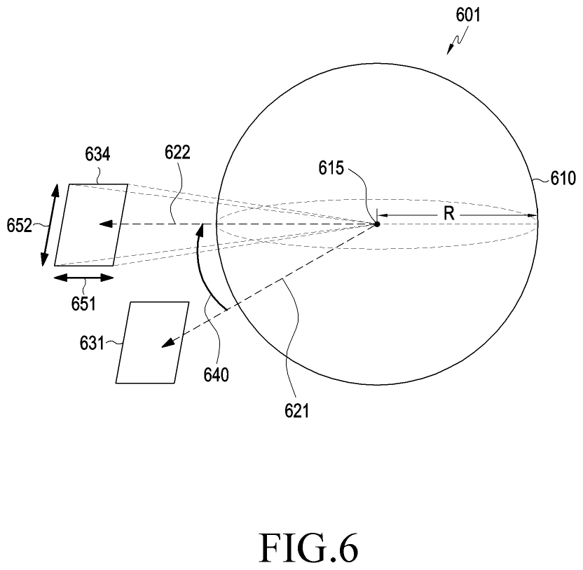

FIG. 5 is a flowchart illustrating an example operation of displaying an omni-directional image by an electronic device according to various embodiments of the present invention.

Referring to FIG. 5, in operation 510, an electronic device (e.g., the electronic device 101 or 302) may identify image data. For example, the image data may be an omni-directional image captured by the electronic device or received from an external electronic device (e.g., the image capturing device 301) via a communication circuit 420.

In operation 520, the electronic device may analyze the received image data. For example, the processor 410 of the electronic device may perform image data analysis.

In operation 530, the electronic device may identify settings for displaying the image data based on the analysis. For example, the processor of the electronic device may identify coordinate information about an object captured in the image data and identify setting information that allows the object to be displayed in a specific position (e.g., the center of the image).

In operation 540, the electronic device may display the image data according to the identified setting. For example, the processor may control to display the image data on the display device 430 according to the identified setting.

According to various embodiments of the present invention, a method of displaying an omni-directional image by an electronic device comprise receiving the omni-directional image from an external electronic device, storing the omni-directional image in a memory of the electronic device, performing analysis on the received omni-directional image, selecting one of a plurality of display settings for the omni-directional image based on, at least, the analysis, and displaying the omni-directional image on a display according to the selected display setting.

According to various embodiments, the plurality of display settings may include at least two of an equirectangular format, a cubic format, a little planet cylindrical panorama format, an arc format, a rectilinear format, or a partial spherical format.

According to various embodiments of the present invention, the method of displaying the omni-directional image by the electronic device may further comprise performing analysis on raw data of the omni-directional image to analyze an object or pattern.

According to various embodiments of the present invention, the method of displaying the omni-directional image by the electronic device may further comprise determining whether a user of the electronic device has been captured in the omni-directional image by analyzing a form of an object captured in the omni-directional image, as the user of the electronic device is captured in the omni-directional image, and processing the omni-directional image to allow an object corresponding to the user to be positioned in a center of a two-dimension image.

According to various embodiments of the present invention, the method of displaying the omni-directional image by the electronic device may further comprise identifying a display setting which has been selected by the user a designated number of times or more among the plurality of display settings, and converting the omni-directional image into a two-dimension image according to the identified display setting.

According to various embodiments of the present invention, the method of displaying the omni-directional image by the electronic device may further comprise, when an object corresponding to a figure cannot be identified or a background corresponding to a predesignated position is captured in the omni-directional image, converting the omni-directional image into a two-dimension image to allow an image area in a designated view direction of the omni-directional image in a panoramic form to be positioned in a center.

According to various embodiments of the present invention, the method of displaying the omni-directional image by the electronic device may further comprise, as a designated application or menu is selected, displaying a list of a plurality of omni-directional images stored in the electronic device, when a first omni-directional image in the list is selected, processing the first omni-directional image according to at least one display setting to thereby generate at least one two-dimension image, and displaying the at least one generated two-dimension image.

According to various embodiments of the present invention, the method of displaying the omni-directional image by the electronic device may further comprise allowing different users to receive information about the number of times in which the at least one display setting has been selected from a server through the communication circuit, and displaying the at least one two-dimension image in an order corresponding to the received information.

According to various embodiments of the present invention, the method of displaying the omni-directional image by the electronic device may further comprise identifying a predesignated display order depending on a kind of object captured in the omni-directional image, and displaying the at least one two-dimension image in the identified display order.

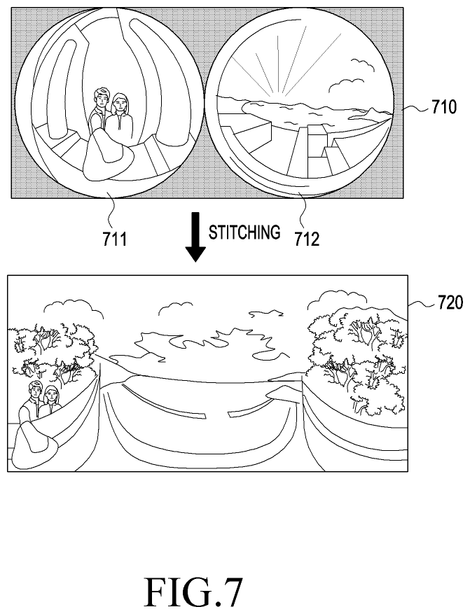

FIG. 6 is a view illustrating a 3D space according to various embodiments of the present invention.

Referring to FIG. 6, a 3D space 601 may be implemented by at least one of an electronic device (e.g., the electronic device 101 or 302), a processor of the electronic device, or a controller of the processor.

The 3D space 601 may be implemented by texture-mapping a wide-angle image or video to a preset 3D model 610 (e.g., a sphere having a preset radius R, a cube, or a cylinder) and positioning the user's gaze point (or virtual camera) inside (e.g., at the origin point 615) of the 3D model.

The electronic device may render a first partial image 631 (or a first screen) corresponding to a first region of the 3D space 601 according to a first gaze point (e.g., the main camera gaze point) 621 and display the same on a display (e.g., the display 160).

According to selection of a view mode (or an input for changing the gaze point), i.e., according to the angle 640 moved from the first gaze point 621 to the selected gaze point 622, the electronic device may render a second partial image 634 (or second screen) corresponding to a second region of the 3D space 601 and display the same on the display (e.g., the display device 160).

The camera or user's line of sight (or viewing direction, rendering view port or rendering region) within the 3D space 601 may be controlled by a horizontal field of view (FOV) 651 and a vertical FOV 652. The 3D application (or VR application) may set planes (e.g., right/left/top/bottom/near/far planes) limiting/defining the rendering view port, controlling the FOVs.

According to an embodiment of the present invention, the gaze point may be varied by moving the user's body part (e.g., eye, head, torso, or hand), and the second image may be generated corresponding to the change in gaze point. The gaze point may be varied or the change in gaze point may be controlled by a signal received from an external device or an external user.

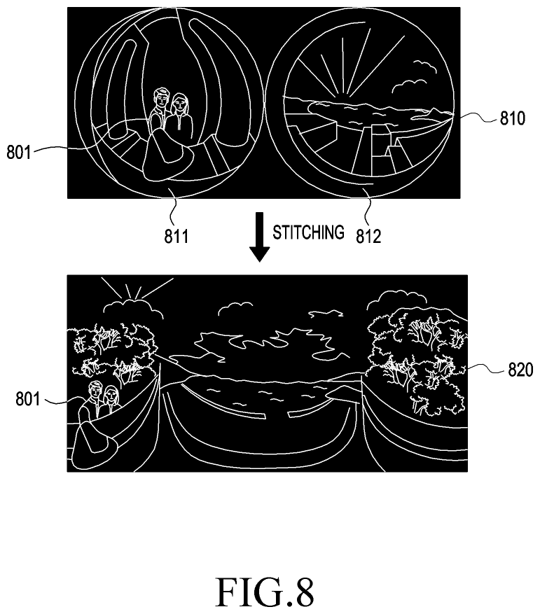

FIG. 7 is a view illustrating an example omni-directional image converted into a two-dimension image according to various embodiments of the present invention.

Referring to FIG. 7, an omni-directional image may be generated by mapping a plurality of images (e.g., a first image 711 and a second image 712) captured by a plurality of lenses included in an image capturing device to a two-dimension image 720. For example, the omni-directional image may be one transferred to the electronic device via an image capturing device (e.g., the camera module 180 or image capturing device 301) internally/externally connected with the electronic device (e.g., the electronic device 101 or 302) and capturing the omni-directional image.

According to various embodiments of the present invention, the electronic device may map the a plurality of captured images (e.g., the first image 711 and the second image 712) to a sphere and stitch the contacts of the mapped image 710 to thereby convert into a two-dimension image 720. For example, the electronic device may identify objects captured in the omni-directional image and perform stitching so that the objects are repositioned and displayed in the two-dimension image 720.

According to various embodiments of the present invention, the electronic device may stitch the mapped image 710 by setting the position of the object depending on the form of the object captured in the omni-directional image. For example, upon detecting a designated background in the omni-directional image, the electronic device may stitch the mapped image 710 into a two-dimension image 720 so that the background detected in the panoramic form is positioned in the center of the image.

According to various embodiments of the present invention, the electronic device may stitch into the two-dimension image in various forms depending on the form or kind of objects captured in the omni-directional image.

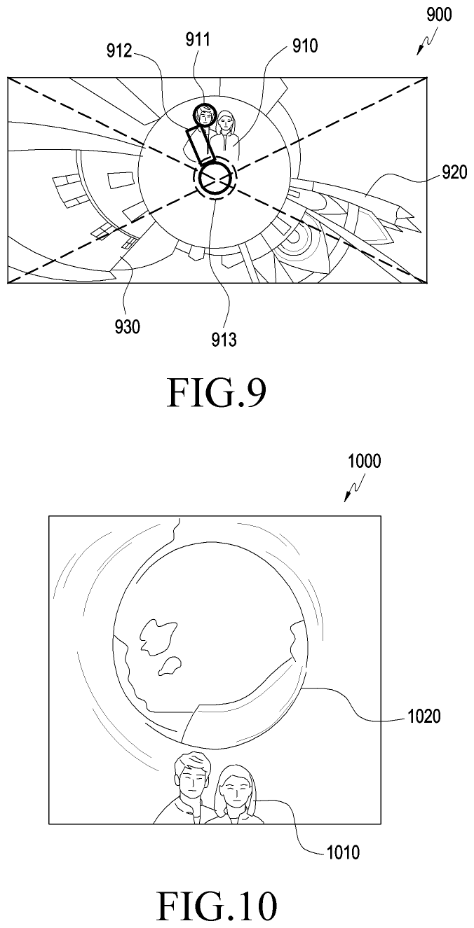

FIG. 8 is a view illustrating an example omni-directional image before circle center candidate value transform is performed according to various embodiments of the present invention.

Referring to FIG. 8, an omni-directional image is configured of two images (e.g., a first image 811 and a second image 812) captured by fisheye lenses, and an electronic device (e.g., the electronic device 101 or 400) may perform circle center candidate value (e.g., Hough) transform on the omni-directional image.

According to various embodiments of the present invention, the circle center candidate value transform may be a process for detecting points constituting a form of object in the grayscale effect-applied omni-directional image and detecting a figure formed of lines meeting other tangents exceeding a designated detection parameter value among tangents to the detected points. For example, as the detection parameter value increases, a smaller number of figures may be detected in the omni-directional image.

According to various embodiments of the present invention, the electronic device may perform the circle center candidate value transform and identify an image 810 in which the two images of the omni-directional image have been mapped to a sphere. The mapped image 810 may include lines or figures according to the shape of the detected objects.

According to various embodiments of the present invention, the electronic device may identify whether the shape of the object corresponds to a specific figure (e.g., a circle, rectangle or triangle) or may perform face recognition, thereby determining whether the object is the user of the electronic device, a particular thing, or the background.

According to various embodiments of the present invention, the electronic device may detect the object 801 corresponding to the user of the electronic device among identified objects. For example, as the object 801 has a specific shape (e.g., a circle corresponding to the arm holding the electronic device or the face), the electronic device may determine that the object 801 is the user of the electronic device.

According to various embodiments of the present invention, the electronic device may perform stitching on the mapped image 810 that has undergone the circle center candidate value transform. By stitching the circle center candidate value transformed mapped image 810, the electronic device may generate a two-dimension image 820 of the omni-directional image in a panoramic form.

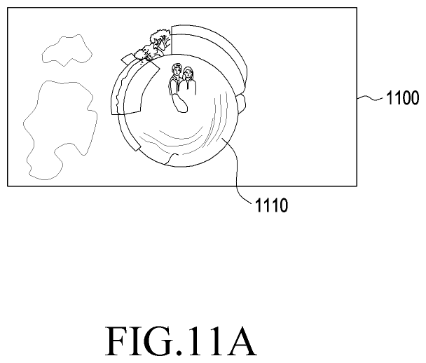

FIG. 9 is a view illustrating an example of an omni-directional image displayed on an electronic device according to various embodiments of the present invention.

Referring to FIG. 9, an electronic device (e.g., the electronic device 101 or 302) may perform circle center candidate value transform on an omni-directional image and perform stitching, thereby generating a two-dimension image 900. For example, as the circle center candidate value transform is performed, the electronic device may identify that an object corresponding to a person 910, a church building 920 or house 930 is detected from the omni-directional image.

According to various embodiments of the present invention, the electronic device may perform circle center candidate value transform to thereby extract the contour and identify the kind of the captured object according to the shape of the figure constituted of the extracted lines. For example, if the lines extracted are shaped as a first circle 913, a rectangle 912 adjacent to the first circle, and a second circle 911 adjacent to the rectangle, the electronic device may determine that the object is the user who holds a camera and takes a shot.

According to various embodiments of the present invention, upon determining that the user has been captured in the omni-directional image, the electronic device may stitch the omni-directional image into the two-dimension image 900 so that the data in the view direction along which the user has been captured is positioned in the center of the two-dimension image 900.

According to various embodiments of the present invention, the electronic device may stitch the omni-directional image into the two-dimension image 900 to be displayed in the planet format. For example, the planet format may be a display setting in which the two-dimension image 900 is displayed as if the user has been captured from above the user. The two-dimension image 900 may be one stitched so that a circular ground is formed around the user, with buildings (e.g., the church building 920 or house 930) placed on the ground.

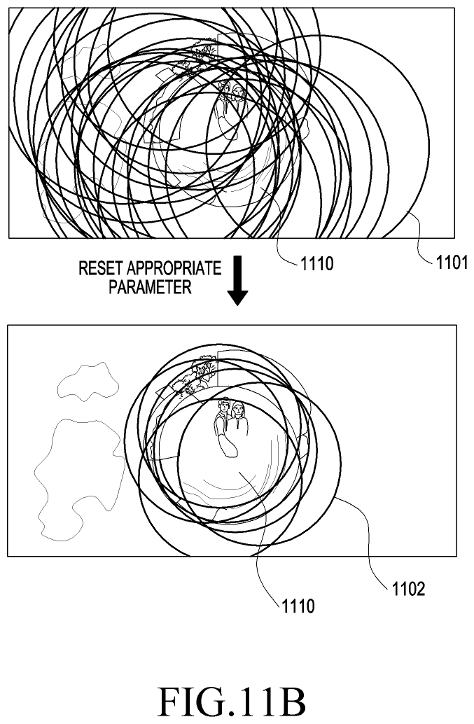

FIG. 10 is a view illustrating an example of an omni-directional image displayed on an electronic device according to various embodiments of the present invention.

Referring to FIG. 10, an electronic device (e.g., the electronic device 101 or 302) may perform circle center candidate value transform on an omni-directional image and perform stitching, thereby generating a two-dimension image 1000. For example, as the circle center candidate value transform is performed, the electronic device may identify that an object corresponding to a person 1010 and background 1020 is detected from the omni-directional image.

According to various embodiments of the present invention, the electronic device may stitch the omni-directional image into the two-dimension image 1000 to be displayed in another planet format. For example, the other planet format may be a display setting in which display is done as if the person 1010 has been captured from ahead of the person 1010. The person 1010 may be placed under the center of the two-dimension image 1000, with a planet shape placed above the person 1010 in the background.

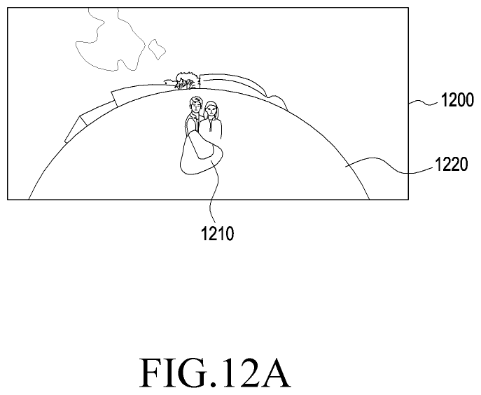

FIGS. 11A and 11B are views illustrating various example omni-directional images to which various transform schemes are applied to identify display settings according to various embodiments of the present invention.

Referring to FIG. 11A, a two-dimension image 1100 may be one stitched from an omni-directional image so that a ground 1110 is shaped as a circle around an object corresponding to a person, and the background is placed around the ground.

According to various embodiments of the present invention, an electronic device (e.g., the electronic device 101 or 302) may determine whether the ground is shaped as a full circle by circle center candidate value (e.g., Hough) transform and edge value threshold (e.g., canny edge) detection algorithm. For example, the edge corresponding to the contour of the object captured in the omni-directional image may be detected using the edge value threshold detection algorithm.

Referring to FIG. 11B, an electronic device may extract a plurality of circles 1101 by performing circle center candidate value transform and edge value threshold detection algorithm on the two-dimension image 1100. If the plurality of circles 1101 more than a designated number are extracted as a result of performing the circle center candidate value transform and edge value threshold detection algorithm, the electronic device may reset suitable parameters of the circle center candidate value transform and edge detection algorithm.

According to various embodiments of the present invention, the suitable parameters of the circle center candidate value transform may include image size or minimum/maximum radii. The suitable parameters of the edge value threshold detection algorithm may include thresholds for setting the direction and size of gradients of the pixels of the omni-directional image.

According to various embodiments of the present invention, if, as the suitable parameters, the angle of the straight line of dots, the gradient size, and radius, respectively, are set to 60 degrees, 100%, and a value between 130 and 180, circles 1101 more than the designated number may be detected as a result of performing the circle center candidate value transform and edge value threshold detection algorithm.

According to various embodiments of the present invention, the suitable parameters may be reset. For example, the angle of straight line may be reset to 70 degrees, and the radius from 100 to 130, and the circles 1102 may then be detected. Upon identifying that circles not more than the designated number are detected as a result of resetting the suitable parameters, the electronic device may determine the center and size of the circle corresponding to the shape of the ground in the two-dimension image 1100 based on the detected circles.

According to various embodiments of the present invention, the electronic device may perform circle center candidate value transform and edge value threshold detection algorithm on the omni-directional image to thereby detect a full circle and may stitch into a two-dimension image according to various display settings, based on the detected full circle.

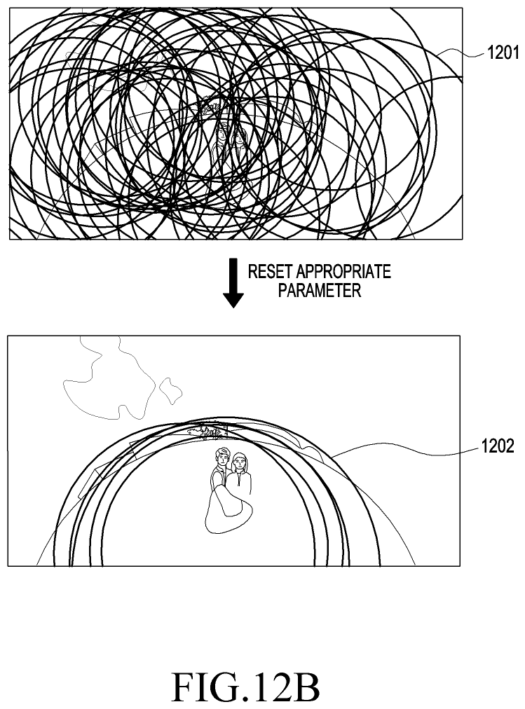

FIGS. 12A and 12B are views illustrating various example omni-directional images to which various transform schemes are applied to identify display settings according to various embodiments of the present invention.

Referring to FIG. 12A, a two-dimension image 1200 may be one stitched from an omni-directional image so that a ground 1220 is shaped as a semi-circle around an object 1210 corresponding to a person, and the background is placed around the semi-circular ground.

According to various embodiments of the present invention, an electronic device (e.g., the electronic device 101 or 302) may determine whether the ground is shaped as a semi-circle by circle center candidate value transform and edge value threshold detection algorithm.

Referring to FIG. 12B, an electronic device may extract a plurality of circles 1201 by performing circle center candidate value transform and edge value threshold detection algorithm on the two-dimension image 1200. If the plurality of circles 1201 more than a designated number are extracted as a result of performing the circle center candidate value transform and canny edge detection algorithm, the electronic device may reset suitable parameters of the circle center candidate value transform and edge detection algorithm.

According to various embodiments of the present invention, if, as the suitable parameters, the angle of the straight line of dots, the gradient size, and radius, respectively, are set to 60 degrees, 100%, and a value between 130 and 180, circles more than the designated number may be detected as a result of performing the circle center candidate value transform and edge value threshold detection algorithm.

According to various embodiments of the present invention, the suitable parameters may be reset. For example, the angle of a straight line may be reset to 70 degrees, and the radius may be reset from 100 to 130. Upon identifying that circles 1202 not more than the designated number are detected as a result of resetting the suitable parameters, the electronic device may determine the center and size of the semi-circle corresponding to the shape of the ground in the two-dimension image 1200 based on the detected circles.

According to various embodiments of the present invention, the electronic device may perform circle center candidate value transform and edge value threshold detection algorithm on the omni-directional image to thereby detect a semi-circle and may stitch into a two-dimension image according to various display settings, based on the detected semi-circle.

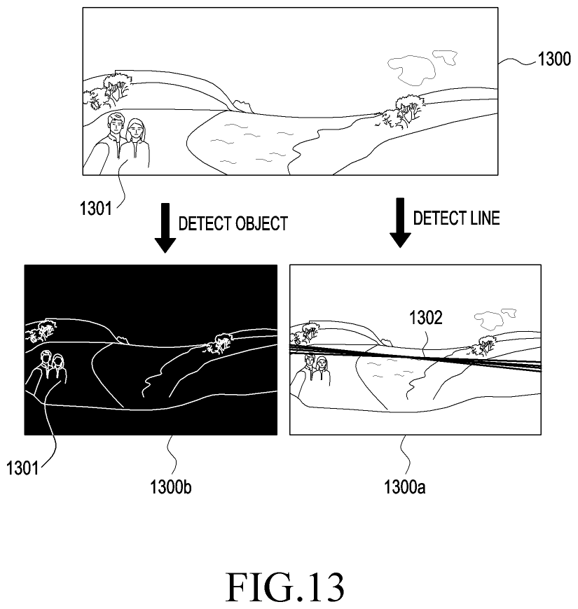

FIGS. 13, 14, and 15 are views illustrating various operations for detecting a line from an omni-directional image to identify display settings according to various embodiments of the present invention.

Referring to FIG. 13, a two-dimension image 1300 may be one stitched in a panoramic form of an object 1301 corresponding to a person and a background detected from an omni-directional image.

According to various embodiments of the present invention, an electronic device (e.g., the electronic device 101 or 302) may apply circle center candidate value transform and edge value threshold detection algorithm to the two-dimension image 1300, detect at least one line 1302 from the edge value threshold detection algorithm-applied image 1300a, and detect an object 1301 corresponding to a person from the circle center candidate value transform-performed two-dimension image 1300b.

According to various embodiments of the present invention, the electronic device (e.g., the electronic device 101 or 302) may perform color inversion on the circle center candidate value transform-performed two-dimension image 1300b to separately display the edge and non-edge portion.

According to various embodiments of the present invention, the electronic device may distinguish between the ground and the background except for the ground in the two-dimension image 1300 based on the detected lines. For example, as the suitable parameters, the angle of straight line and the gradient size may be set to 95 degrees and 150%, respectively.

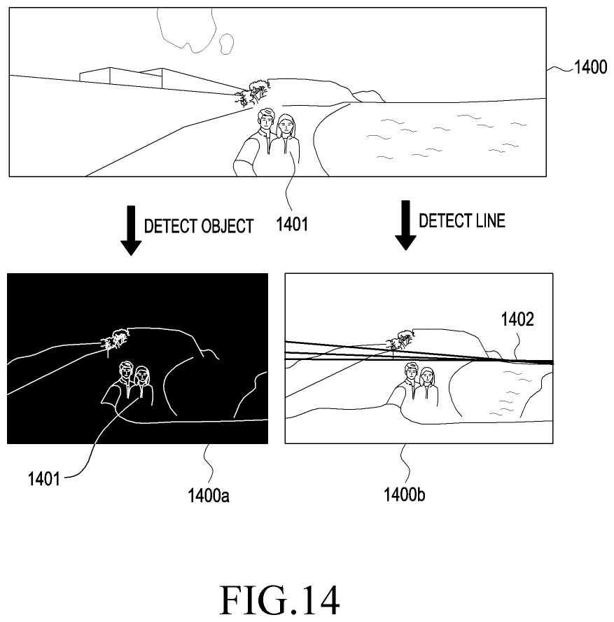

Referring to FIG. 14, a two-dimension image 1400 may be one stitched in a panoramic form of an object corresponding to a person and a background detected from an omni-directional image, with the object 1401 corresponding to the person placed under the center of the image.

According to various embodiments of the present invention, an electronic device (e.g., the electronic device 101 or 302) may perform circle center candidate value transform and edge value threshold detection algorithm and detect the object 1401 corresponding to the person from the circle center candidate value transform-performed two-dimension image 1400a, and detect at least one line 1402 from the edge value threshold detection algorithm-applied image 1400b.

According to various embodiments of the present invention, the electronic device (e.g., the electronic device 101 or 302) may perform color inversion on the circle center candidate value transform-performed two-dimension image 1400a to separately display the edge and non-edge portion.

According to various embodiments of the present invention, the electronic device may distinguish between the ground and the background except for the ground in the edge value threshold detection algorithm-applied two-dimension image 1400b based on the detected lines. For example, as the suitable parameters, the angle of a straight line and the gradient size may be set to 95 degrees and 150%, respectively.

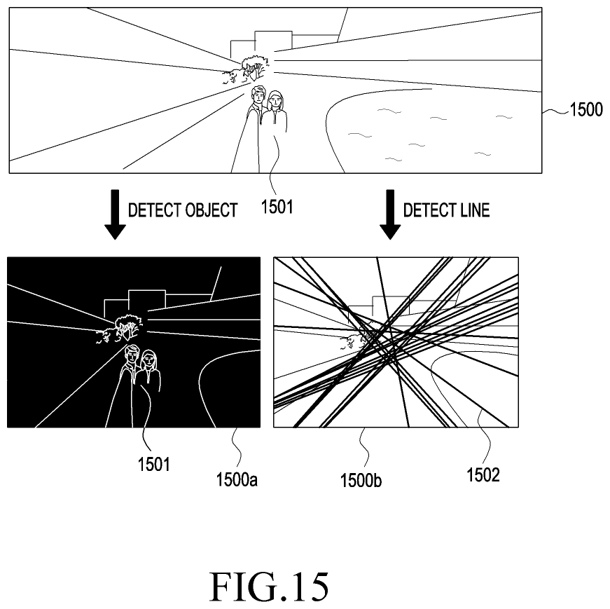

Referring to FIG. 15, a two-dimension image 1500 may be one stitched in a panoramic form of an object corresponding to a person and a background detected from an omni-directional image, with the object 1501 corresponding to the person placed in the center of the image.

According to various embodiments of the present invention, an electronic device (e.g., the electronic device 101 or 302) may perform circle center candidate value transform and edge value threshold detection algorithm and detect the object 1501 corresponding to the person from the circle center candidate value transform-performed two-dimension image 1500a. For example, at least one line 1502 may be detected from the edge value threshold detection algorithm-applied image 1500b.

According to various embodiments of the present invention, the electronic device (e.g., the electronic device 101 or 302) may perform color inversion on the circle center candidate value transform-performed two-dimension image 1400a to separately display the edge and non-edge portion.

According to various embodiments of the present invention, the electronic device may distinguish between the ground and the background except for the ground in the edge value threshold detection algorithm-applied two-dimension image 1500b based on the detected lines 1502. For example, as the suitable parameters, the angle of a straight line and the gradient size may be set to 60 degrees and 150%, respectively.

According to various embodiments of the present invention, the electronic device may reset the suitable parameters as the number of the detected lines 1502 exceeds a designated value.

According to various embodiments of the present invention, the electronic device (e.g., the electronic device 101 or 302) may perform circle center candidate value transform and edge value threshold detection algorithm on the omni-directional image, detect a plurality of lines from an image 1500b obtained as a result of performing them, and determine the border between the background and object in the image based on the detected lines. For example, based on the background determined using the image 1500b, the electronic device may stitch the omni-directional image into a two-dimension image in various panoramic forms, such as placing the object 1501 corresponding to the person in the center of the image or placing the background in the center of the image.

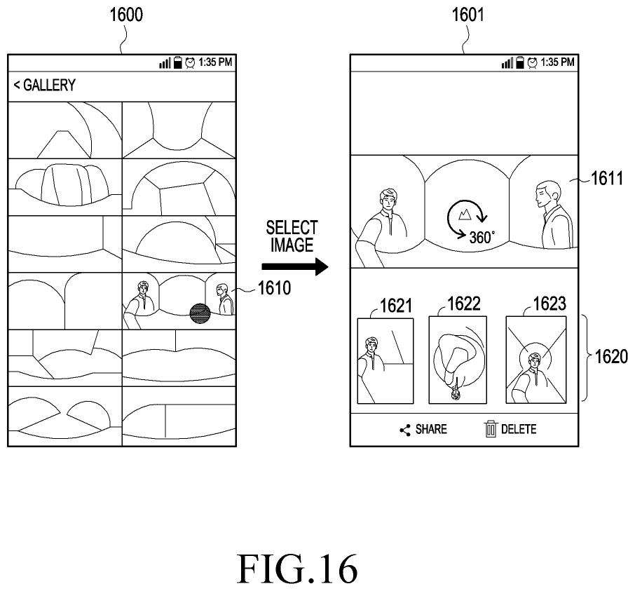

FIG. 16 is a view illustrating an example screen layout displaying a list of omni-directional images stored in an electronic device according to various embodiments of the present invention.

Referring to FIG. 16, an electronic device (e.g., the electronic device 101 or 302) may display a list of omni-directional images stored in the electronic device. For example, the screen 1600 displaying the list of omni-directional images may be displayed as a designated application or menu is executed.

According to various embodiments of the present invention, the list of omni-directional images may be displayed with thumbnail images of two-dimension images separately corresponding to the omni-directional images. The two-dimension images displayed as the thumbnail images may be ones resultant from stitching the omni-directional images according to a specific display setting, based on the preference of users of the application or the preference of the user for various display settings.

According to various embodiments of the present invention, the server 108 may store information, such as the display setting which the users of the application have selected the most or the display setting selected the most depending on the kind (e.g., person or background) of object, as preference information for the users. For example, the server 108 may select the preference of a specific user based on the preference information or a specific display setting depending on the kind of captured object, transmit information about the selected display setting, along with raw data, to the electronic device (e.g., 101 or 302), or stitch into a two-dimension image depending on the selected display setting and transmit the two-dimension image to the electronic device (e.g., 101 or 302).

If among the images displayed in the omni-directional image list, a first image 1610 is selected, the electronic device may switch the screen 1600 of the application into an execution screen 1601 including an item 1611 for displaying the omni-directional image corresponding to the first image 1610 and a region 1620 displaying the two-dimension images (e.g., 1621, 1622, and 1623) of different display settings, generated using the omni-directional image, and display the execution screen 1601.

According to various embodiments of the present invention, if the item 1611 is selected, the omni-directional image may be mapped to a three-dimensional space and displayed. The electronic device may display the image in the region corresponding to the view direction corresponding to the display of the electronic device among the omni-directional images based on the slope of the electronic device or various user inputs.

According to various embodiments of the present invention, the two-dimension images (e.g., 1621, 1622, and 1623) generated using the omni-directional image may be ones resultant from performing stitching in the display setting of panorama or planet format depending on the kind (e.g., a person, thing, or landscape) of the object captured in the omni-directional image.

According to various embodiments of the present invention, if the user's preference to the at least one display setting may not be identified, the electronic device may display a two-dimension image 1623, in which the ground in a circular planet shape surrounds the object corresponding to the person, and the background surrounds the ground, first among the two-dimension images (e.g., 1621, 1622, and 1623).

According to various embodiments of the present invention, the electronic device may identify the order of display of the two-dimension images (e.g., 1621, 1622, and 1623) based on the distribution of objects captured in the omni-directional image. If, among the objects captured in the omni-directional image, an object over the horizon is larger than a designated size or has a designated shape (e.g., such as of a mountain or building), the two-dimension image 1623 may be displayed first among the two-dimension images (e.g., 1621, 1622, and 1623). If, among the objects captured in the omni-directional image, an object under the horizon is larger than a designated size or has a designated shape (e.g., such as of an animal or person), the two-dimension image 1621 which has been captured in a panoramic form may be displayed first among the two-dimension images (e.g., 1621, 1622, and 1623).

According to various embodiments of the present invention, if the objects captured in the omni-directional image are smaller than the designated size, the two-dimension image 1621 captured in a panoramic form may be displayed first among the two-dimension images (e.g., 1621, 1622, and 1623).

Table 1 shows example priorities of display settings of the omni-directional image designated depending on scenes or captured objects.

TABLE 1

| Scene | Display setting priority |
|---|---|
| Default value | user-centered ground planet view (e.g., 1,100) > |
| | sky-centered planet view, with the user placed |
| | under (e.g., 1,000) > panoramic view, with the |
| | user placed under the center (e.g., 1,400) > |
| | user-centered panoramic view (e.g., 1,500) |
| scene in which an | user-centered ground planet view > panoramic |
| object not less than a | view with the ground displayed as a semi-circle |
| designated size over | (e.g., 1,200) |
| the horizon has been | |
| captured | |
| scene in which an | panoramic view with the user placed under the |
| object not less than a | center > sky-centered planet view with the user |
| designated size under | placed under |
| the horizon has been | |
| captured | |
| scene in which no | user-centered panoramic view (e.g., 1,500) |
| object not less than a | |
| designated size has | |
| been captured | |

Although Table 1 shows the priorities of display settings depending on various scenes or objects, embodiments are not limited thereto and the priority of display settings may be varied based on, e.g., the user's preferences or various pieces of meta data included in the omni-directional image. The omni-directional image may be converted into a two-dimension image according to other various display settings. According to various embodiments of the present invention, the electronic device (e.g., 101 or 302) may display the omni-directional image list stored and, when one is selected from the list, convert the selected omni-directional image into two-dimension images according to at least one display setting and display the two-dimension images. For example, the two-dimension images may be sorted and displayed depending on the display setting priorities.

According to various embodiments of the present invention, the electronic device (e.g., 101 or 302) may determine the kind of objects captured in the omni-directional image and the sizes among the objects to thereby make display settings, and stitch and display the omni-directional image according to the display settings. The user may identify the omni-directional image processed into the two-dimension image according to a specific display setting even without additional manipulation on the captured omni-directional image.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to various embodiments of the present invention, there is provided a storage medium storing instructions configured to be executed by at least one circuit to enable the at least one circuit to perform at least one operation that may include receiving the omni-directional image from an external electronic device, storing the omni-directional image in a memory of the electronic device, performing analysis on the received omni-directional image, selecting one of a plurality of display settings for the omni-directional image based on, at least, the analysis, and displaying the omni-directional image on a display according to the selected display setting.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added.

Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device, comprising:
at least one wireless and/or wired communication circuit;
a display;
a processor operatively connected with the communication circuit and the display; and
a memory operatively connected with the processor and storing an application including a user interface configured to display an omni-directional image on the display, wherein
the memory stores instructions executed to enable the processor to
receive the omni-directional image via the communication circuit,
store the omni-directional image in the memory,
perform analysis on the received omni-directional image,
select one of a plurality of display settings for the omni-directional image based on, at least, the analysis, and
display the omni-directional image on the display according to the selected display setting.

2. The electronic device of claim 1, wherein the plurality of display settings include at least two of an equirectangular format, a cubic format, a little planet cylindrical panorama format, an arc format, a rectilinear format, or a partial spherical format.

3. The electronic device of claim 1, wherein the instructions are configured to enable the processor to perform analysis on raw data of the omni-directional image to analyze an object or pattern.

4. The electronic device of claim 2, wherein the instructions are configured to enable the processor to
determine whether a user of the electronic device has been captured in the omni-directional image by analyzing a form of an object captured in the omni-directional image and
as the user of the electronic device is captured in the omni-directional image, process the omni-directional image to allow an object corresponding to the user to be positioned in a center of a two-dimension image.

5. The electronic device of claim 4, wherein the instructions are configured to enable the processor to
identify a display setting which has been selected by the user a designated number of times or more among the plurality of display settings and
convert the omni-directional image into a two-dimension image according to the identified display setting.

6. The electronic device of claim 3, wherein the instructions are configured to enable the processor to, when an object corresponding to a figure cannot be identified or a background corresponding to a predesignated position is captured in the omni-directional image, convert the omni-directional image into a two-dimension image to allow an image area in a designated view direction of the omni-directional image in a panoramic form to be positioned in a center.

7. The electronic device of claim 1, wherein the instructions are configured to enable the processor to
as a designated application or menu is selected, display a list of a plurality of omni-directional images stored in the electronic device,
when a first omni-directional image in the list is selected, process the first omni-directional image according to at least one display setting to thereby generate at least one two-dimension image,
allow different users to receive information about the number of times in which the at least one display setting has been selected from a server through the communication circuit, and
display the at least one two-dimension image in an order corresponding to the received information.

8. The electronic device of claim 7, wherein the instructions are configured to enable the processor to identify a predesignated display order depending on a kind of object captured in the omni-directional image and
display the at least one two-dimension image in the identified display order.

9. A method of displaying an omni-directional image by an electronic device, the method comprising:
receiving the omni-directional image from an external electronic device;
storing the omni-directional image in a memory of the electronic device;
performing analysis on the received omni-directional image;
selecting one of a plurality of display settings for the omni-directional image based on, at least, the analysis; and
displaying the omni-directional image on a display according to the selected display setting.

10. The method of claim 9, further comprising performing analysis on raw data of the omni-directional image to analyze an object or pattern.

11. The method of claim 9, further comprising:
determining whether a user of the electronic device has been captured in the omni-directional image by analyzing a form of an object captured in the omni-directional image;
as the user of the electronic device is captured in the omni-directional image, processing the omni-directional image to allow an object corresponding to the user to be positioned in a center of a two-dimension image;
identifying a display setting which has been selected by the user a designated number of times or more among the plurality of display settings; and
converting the omni-directional image into a two-dimension image according to the identified display setting.

12. The method of claim 10, further comprising, when an object corresponding to a figure cannot be identified or a background corresponding to a predesignated position is captured in the omni-directional image, converting the omni-directional image into a two-dimension image to allow an image area in a designated view direction of the omni-directional image in a panoramic form to be positioned in a center.

13. The method of claim 9, further comprising:
as a designated application or menu is selected, displaying a list of a plurality of omni-directional images stored in the electronic device;
when a first omni-directional image in the list is selected, processing the first omni-directional image according to at least one display setting to thereby generate at least one two-dimension image; and
displaying the at least one generated two-dimension image.

14. The method of claim 13, further comprising:
allowing different users to receive information about the number of times in which the at least one display setting has been selected from a server through the communication circuit; and
displaying the at least one two-dimension image in an order corresponding to the received information.

15. The method of claim 13, further comprising:
identifying a predesignated display order depending on a kind of object captured in the omni-directional image; and
displaying the at least one two-dimension image in the identified display order.
